(19) United States
(12) Patent Application Publication
(10) Pub. No.: US 2009/0230577 A1
(43) Pub. Date: Sep. 17, 2009

(54) METHOD OF PRODUCING INDENTED SHEET

(76) Inventor: Shotaro Ogawa, Shizuoka (JP)

Correspondence Address: BIRCH STEWART KOLASCH & BIRCH, PO BOX 747, FALLS CHURCH, VA, 22040-0747, US

(21) Appl. No.: 12/294,198

(22) PCT Filed: Mar. 20, 2007
(86) PCT No.: PCT/JP2007/056520

§ 371 Date: Sep. 23, 2008

(30) Foreign Application Priority Data
Mar. 24, 2006 (JP) 2006 084033

(51) Int. Cl. B29D 11/00; B29C 35/10

(52) U.S. Cl. 264/1.6; 264/496

(57) ABSTRACT

The present invention provides a sheet-shaped object on which surface a regular, fine indented pattern is formed, without a decrease in accuracy of the formed pattern structure or defects caused by peeling faults. The present invention also provides a method of producing an indented sheet on which indents on an indented roller surface are transferred onto a surface of a sheet-shaped object. In order to solve the problems above, the method comprises the steps of: continuously running a band-shaped flexible sheet-shaped object; coating a radiation curable resin solution on a surface of the continuously running sheet-shaped object to form a coated layer; transferring indents on the indented roller surface onto the coated layer with the continuously running sheet-shaped object being wound onto the rotating indented roller; curing the coated layer by irradiating radiation with the continuously running sheet-shaped object being wound onto the indented roller; and peeling the continuously running sheet-shaped object from the indented roller, wherein the transferring step, curing step, and peeling step are carried out inside a casing, and temperature and humidity in the casing are each controlled to be within a certain variation range with respect to a target value.

### TECHNICAL FIELD

The present invention relates to a method of producing an indented sheet, and particularly to a method of producing an indented sheet which is preferable for producing a sheet-shaped object, such as an embossed sheet, having an anti-reflection effect and the like, on which surface a regular, fine indented pattern is formed, without any defects and with good quality.

### BACKGROUND ART

Recently, embossed sheets having an anti-reflection effect are being employed for use in electronic displays such as liquid crystal. Examples of these embossed sheets include planar lenses such as a lenticular lens and a fly eye lens; a light diffusion sheet, a brightness enhancement sheet, an optical waveguide sheet and the like. As such embossed sheets, sheets having a surface formed with a regular, fine indented pattern are conventionally known. Methods for forming such a regular, fine indented pattern include various known methods (see Japanese Patent Laid-Open Nos. 11-262958, 11-300768, 2001-314815, 2002-67057, 2002-365405 and 2001-314815).

For example, the background art discloses an apparatus such as that illustrated in FIG. 6, wherein a resin is coated by a coating device 2 onto a surface of a stamper roller 1 having a regular indented pattern formed thereon, a continuously-running sheet 3 is nipped by the stamper roller 1 and a nip roller 4, and with the resin of the stamper roller 1 in contact with the sheet 3, ionizing radiation is irradiated on the resin, after which the sheet 3 is wound onto a release roller 5 and peeled away from the stamper roller 1.

The background art also discloses an apparatus such as that illustrated in FIG. 7, wherein a resin is pre-coated onto a surface of a continuously-running sheet 3, the sheet 3 is nipped by a stamper roller 1 having a regular, indented pattern formed thereon and a nip roller 4, and with the indented pattern of the stamper roller 1 transferred onto the resin, ionizing radiation is irradiated onto the resin, after which the sheet 3 is wound onto a release roller 5 and peeled away from the stamper roller 1.

### DISCLOSURE OF THE INVENTION

However, the above-mentioned Japanese Patent Laid-Open Nos. 11-262958, 11-300768, 2001-314815, 2002-67057, 2002-365405 and 2001-314815 are silent regarding the atmospheric conditions for the processes from transfer to curing and peeling. If the temperature or humidity variation range of the atmosphere in which these processes are being carried out is large, there is the problem that a decrease in accuracy of the formed pattern structure and defects caused by peeling faults are more likely to occur.

The present invention has been made in view of the above circumstances, and it is an object of the present invention to provide a method of producing an indented sheet with good quality which is preferable for producing a sheet-shaped object on which surface a regular, fine indented pattern is formed, without a decrease in accuracy of the formed pattern structure or defects caused by peeling faults.

To achieve the above-described object, the present invention provides a method of producing an indented sheet on which indents on an indented roller surface are transferred onto a surface of a sheet-shaped object, characterized by comprising: a sheet running step of continuously running a band-shaped flexible sheet-shaped object; a coating step of coating a radiation curable resin solution on a surface of the continuously running sheet-shaped object to form a coated layer; a transferring step of transferring indents on the indented roller surface onto the coated layer with the continuously running sheet-shaped object being wound onto the rotating indented roller; a curing step of curing the coated layer by irradiating radiation with the continuously running sheet-shaped object being wound onto the indented roller; and a peeling step of peeling the continuously running sheet-shaped object from the indented roller, wherein the transferring step, curing step, and peeling step are carried out inside a casing, and temperature and humidity in the casing are each controlled to be within a certain variation range with respect to a target value.

According to the present invention, the processes from transfer to curing and peeling are carried out inside a casing in which the temperature and humidity are each controlled to be within a certain variation range with respect to a target value. Thus, an indented sheet having good quality can be produced without a decrease in accuracy of the formed pattern structure or defects caused by peeling faults.

In the present application, the term “indented roller” not only refers to an embossing roller on which an indented pattern (for embossed shape) is formed on the surface of a cylindrical roller, but also a structure on which an indented pattern (for embossed shape) is formed on the surface of an endless belt or other such belt-shaped object. Such a belt-shaped object acts in the same manner as a cylindrical roller, and the same effects can be obtained.

In the present invention, air is supplied to and discharged from the casing interior, so that it is preferable to supply into the casing air from which dust has been removed by a filter. The processes from transfer to curing and peeling can thus be carried out in a clean environment, thereby allowing an indented sheet having good quality to be produced.

Further, in the present invention, the air pressure in the casing is preferably set higher than the external air pressure. The temperature and humidity in the casing can thus be prevented from being affected by the atmosphere outside of the casing through a gap in the casing, thereby allowing control of the temperature and humidity in the casing to be carried out in a more stable manner.

Further, in the present invention, it is preferable to supply cooling water into the indented roller. This allows heating up of the indented roller from radiation irradiation to be suppressed, whereby the indented roller can be maintained at a constant temperature. As a result, control of the temperature and humidity in the casing to be carried out in a more stable manner.

Further, in the present invention, it is preferable for the radiation curable resin to be a UV-ray curable resin, and for the radiation to be UV-rays. The pitch of the indented pattern which has been transferred onto the sheet-shaped object is preferably no more than 100 μm. The indented sheet is also preferably used as an optical film.

According to the present invention, the processes from transfer to curing and peeling are carried out inside a casing in which the temperature and humidity are each controlled to be within a certain variation range with respect to a target value, which allows an indented sheet having good quality to be produced without a decrease in accuracy of the formed pattern structure or defects caused by peeling faults.

### BRIEF DESCRIPTION OF THE DRAWINGS

FIG. 1 is a diagram illustrating the structure of a production apparatus for an embossed sheet which is employed in the present invention;

FIG. 2 is a cross-sectional diagram illustrating the concept of an embossing roller;

FIG. 3 is a cross-sectional diagram illustrating the concept of an embossing roller;

FIG. 4 is a table showing the blends of the resin solution;

FIG. 5 is a table showing the conditions and the evaluated results of the Examples and Comparative examples;

FIG. 6 is a schematic diagram illustrating the structure of a conventional production apparatus for an embossed sheet; and

FIG. 7 is a schematic diagram illustrating the structure of another conventional production apparatus for an embossed sheet.

### DESCRIPTION OF SYMBOLS

10 . . . production apparatus for an embossed sheet, 11 . . . sheet supplying device, 12 . . . coating device, 13 . . . embossing roller, 14 . . . nip roller, 15 . . . resin curing device, 16 . . . peeling roller, 17 . . . protective film supplying device, 18 . . . sheet take-up device, 21 . . . defect detection device, 24 . . . first suction drum, 26 . . . second suction drum, 28 . . . dust remover, 30 . . . dancing roller, 32 . . . edge position control device, 40 . . . casing, H . . . protective film, W . . . sheet

### BEST MODE FOR CARRYING OUT THE INVENTION

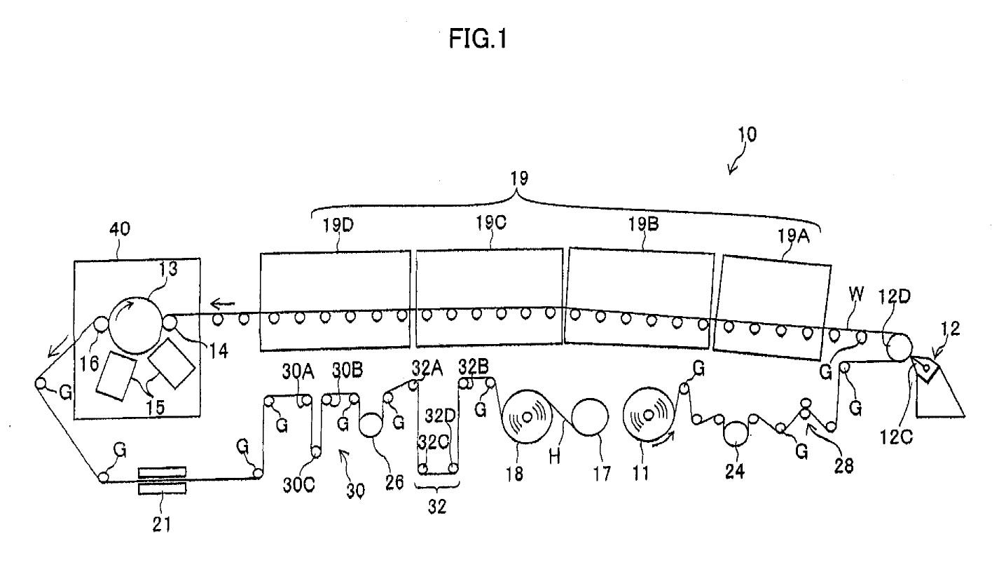

An embodiment of the present invention will now be explained based on the attached drawings. FIG. 1 is a structural diagram illustrating the structure of the production apparatus 10 for an embossed sheet which is used in the present invention.

The production apparatus 10 for an embossed sheet is configured from a sheet supplying device 11, a coating device 12, a drying device 19, an embossing roller 13 which is an indented roller, a nip roller 14, a resin curing device 15, a peeling roller 16, a defect detection device 21, a protective film supplying device 17, a sheet take-up device 18 and the like. A sheet-shaped object sheet W is conveyed while supported by guide rollers G, G from the upstream side (sheet supplying device 11) to the downstream side (sheet take-up device 18).

Since the sheet supplying device 11, which is a sheet-shaped object supplying means, feeds out a sheet W, which is a sheet-shaped object, it is configured by a feeding-out roll around which the sheet W is wound, or the like.

A first suction drum 24 is provided between the sheet supplying device 11 and the coating device 12. As with the below-described second suction drum 26, the first suction drum 24 is a device for supporting by suction the sheet W while also causing the sheet W to continuously run by being rotated at a fixed circumferential velocity. The support by suction of the sheet W may be configured using the suction from a plurality of holes formed on the drum outer circumference surface, or configured by supporting with a plurality of grooves formed on the drum outer circumference surface (groove suction drum).

A dust remover 28 is provided downstream of the first suction drum 24. With this dust remover 28, dust adhered to the surface of the sheet W can be removed. Various well-known devices may be employed for the dust remover 28 system, such as a type which blows dry air from which dust has been removed by static electricity, or as illustrated in the drawings, a type which winds the sheet W onto an adhesive roller.

The coating device 12 is an apparatus which coats a radiation curable resin onto a surface of the sheet W, and is configured from a liquid supplying source which supplies the radiation curable resin and a liquid supplying apparatus (feeding pump), (not shown), a coating head 12C, a support roller 12D which winds and supports the sheet W during coating, and piping (not shown) for supplying the radiation curable resin from the liquid supplying source to the coating head 12C. As the coating head 12C, the coating head of a die coater (extrusion type coater) is used.

Various well-known systems may be employed as the drying device 19, so long as, like the tunnel-shaped drying apparatus illustrated in FIG. 1 for example, the coating solution coated on the sheet W can be evenly dried. For example, a radiation heating system which employs a heater, a hot-air circulation system, a far infrared ray system, a vacuum system or the like may be used.

The drying device 19 illustrated in FIG. 1 is a tunnel-shaped apparatus divided into four blocks, arranged from the upstream side as first block 19A, second block 19B, third block 19C and fourth block 19D. The temperature of each of the blocks can be set individually.

The embossing roller 13 has to be able to transfer the indents on the roller surface onto the surface of the sheet W, and possess accuracy of the indented pattern, mechanical strength, circularity and the like. Rollers made from metal are preferred as the embossing roller 13.

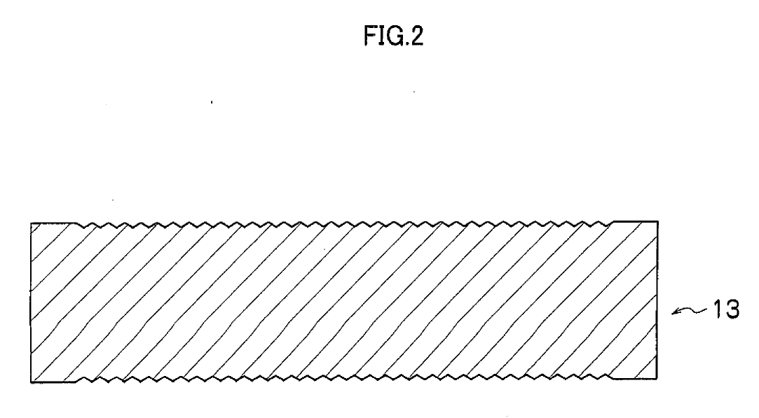

A regular, fine indented pattern is formed on the outer circumference surface of the embossing roller 13. This regular, fine indented pattern needs to be an inverted shape of the fine indented surface pattern of embossed sheets to be produced. A schematic cross-sectional view of the embossing roller 13 is illustrated in FIG. 2.

Examples of items that the indented sheet (embossed sheet) as a product can be used for include a lenticular lens on which the fine indented pattern is arranged two-dimensionally, a fly eye lens on which the fine indented pattern is arranged three-dimensionally, and a flat lens on which fine cones such as circular cones and pyramids are paved in the X and Y directions. The regular, fine indented pattern on the outer circumferential surface of the embossing roller 13 is conformed to the above items.

As the method for forming the regular, fine indented pattern on the outer circumferential surface of the embossing roller 13, the surface of the embossing roller 13 may be cut with a diamond cutting tool (single point), indents may be directly formed on the surface of the embossing roller 13 by photo etching, electron-beam rendering, laser work or the like, or indents may be formed on the surface of a thin metal plate by photo etching, electron-beam rendering, laser work, stereo lithography or the like, and the plate can then be fixed by winding the plate around the roller to make the embossing roller 13.

Further examples include forming indents on the surface of a material which is more easily worked than metal by photo etching, electron-beam rendering, laser work, stereo lithography or the like, to form a mold having an inverse shape of the material by electroforming or the like, then making a thin metal plate and fixing the plate by winding the plate around the circumference of the roller to make the embossing roller 13. Especially when the inverse mold is formed by electroforming or the like, there is the advantage that a plurality of plates having an identical shape can be obtained from one master (mother).

The surface of the embossing roller 13 is preferably subjected to a mold-release treatment. By subjecting the surface of the embossing roller 13 to a mold-release treatment, the shape of the fine indented pattern can be well maintained. Various well-known methods may be used for the mold-release treatment, such as coating with a fluoride resin for instance. The embossing roller 13 is preferably provided with a drive device. As shown by the arrow in the drawings, the embossing roller 13 rotates in a clockwise direction (CW).

The nip roller 14 works as a pair with the embossing roller 13 so as to subject the sheet W to roller molding while pressing down thereon. Therefore, the nip roller 14 is required to have a certain degree of mechanical strength and circularity. The longitudinal elastic modulus (Young's modulus) of the nip roller 14 surface is preferably set at a suitable value, because if it is too small, the roller molding will be insufficient, while if it is too large, defects are liable to occur from the roller due to the easy inclusion of foreign matter such as dirt. The nip roller 14 is preferably provided with driving means. The nip roller 14 rotates in a counterclockwise direction (CCW).

It is preferable to provide pressing means on either the embossing roller 13 or the nip roller 14 for applying a predetermined pressing force between the embossing roller 13 and the nip roller 14. Similarly, it is preferable to provide a fine adjustment device on either the embossing roller 13 or the nip roller 14 to allow precise control of a gap (clearance) between the embossing roller 13 and the nip roller 14.

The resin curing device 15 is a light irradiation device provided opposite to the embossing roller 13 at a downstream side of the nip roller 14. This resin curing device 15 irradiates light through the sheet W to cure the resin solution layer by the light irradiated thereon. It is thus preferable for the resin curing device 15 to be able to irradiate light (radiation) having a wavelength that corresponds to the curing property of the resin, and to be able to irradiate radiation at a level that corresponds to the conveyance rate of the sheet W. Examples of devices which can be employed as the resin curing device 15 include a cylindrical irradiation lamp which has a length that is about the same as that of the sheet W. In addition, a plurality of such cylindrical irradiation lamps may be provided in parallel. A reflective sheet may also be provided on the back face of the cylindrical irradiation lamp. In FIG. 1, a pair of two lamp houses are provided which have a cylindrical irradiation lamp provided in their housing.

The peeling roller 16 is provided counter to the embossing roller 13 and peels the sheet W from the embossing roller 13. The peeling roller 16 thus needs to have a certain level of mechanical strength, circularity and the like. At the peeling point, the sheet W is peeled from the rotating embossing roller 13 and wound onto peeling roller 16 while the sheet W wound on the circumference surface of the embossing roller 13 is nipped by the embossing roller 13 and peeling roller 16. It is preferable to provide a drive device on the peeling roller 16 in order to reliably perform this operation. The peeling roller 16 rotates in a counterclockwise direction (CCW).

In cases where the temperature of the resin or the like increases as a result of curing, a cooling device may be provided on the peeling roller 16 for cooling the sheet W during peeling so that the peeling can be reliably performed.

Though not shown in the drawings, a configuration can be employed wherein a plurality of backup rollers are provided to oppose each other in an area between the pressing location (three o'clock position) of the embossing roller 13 up to the peeling location (nine o'clock position), and curing is performed while the sheet W is pressed with the plurality of backup rollers and the embossing roller 13.

The embossing roller 13, nip roller 14, resin curing device 15 and peeling roller 16 are housed in a casing (housing) 40, which is configured such that the sheet W passes through the casing 40 via two slit-shaped apertures (not shown) formed in the casing 40. This allows the sheet W having a resin layer formed on its surface to be wound onto the rotating embossing roller 13, whereby indents on the surface of the embossing roller 13 are transferred onto the resin layer. With the sheet W wound around the embossing roller 13, radiation is irradiated on the resin layer, whereby the resin layer is cured. The sheet W is then peeled off the embossing roller 13. Thus, the processes from transfer to curing and peeling are carried out inside the casing 40.

The present invention is characterized by controlling both the temperature and the humidity in the casing 40 within a certain variation range with respect to a target value. If there is a large variation in the temperature or humidity of the atmosphere in which the processes from transfer to curing and peeling are being carried out, differences arise in the curing rate or viscosity of the resin, the surface condition of the roll, the force required for peeling and the like. Therefore, when controlling the temperature and the humidity in the casing 40, their variation ranges are preferably kept small. The variation ranges are controlled, more preferably within ±2° C. of the target temperature and ±3% RH of the target humidity, yet more preferably ±1° C. of the target temperature and ±2% RH of the target humidity.

Since ozone or the like is generated from the radiation irradiation, air is supplied to and discharged from the interior of the casing 40. It is preferable to pump into the casing 40 air from which dust has been removed by a filter, and it is preferable to pump in air so that the casing 40 interior has a cleanliness class of 1,000 or less. The processes from transfer to curing and peeling can thus be carried out in a clean environment, thereby allowing an indented sheet having good quality to be produced. Examples of a filter which can be used include HEPA, ULPA and the like.

Further, the air pressure in the casing 40 is preferably set higher than the external air pressure. The air pressure in the casing 40 is preferably set at a pressure of 1.01 to 1.2. Since the air can flow from the casing 40 interior to the outside through a gap in the casing 40 (e.g. the aperture which the sheet W passes through), when controlling the temperature and the humidity in the casing 40, the casing 40 is not susceptible to influence from the external atmosphere, so that control can be carried out in a more stable manner.

Further, it is preferable to supply cooling water into the embossing roller 13. For example, cooling water can be supplied into the embossing roller 13 by utilizing a rotary joint. While in some cases the embossing roller 13 heats up from the radiation irradiation, the embossing roller 13 can be kept at a constant temperature using the cooling water. As a result, the temperature and humidity in the casing 40 can be controlled in a more stable manner. Some other medium may also be used instead of cooling water.

A defect detection device 21 is provided at the downstream side of the peeling roller 16. With such a defect detection device 21, defects in the indented pattern which has been transferred onto the sheet W can be detected, thus making removal of the defective portions easy. Various well-known types of detection devices (e.g. a CCD imager) may be used as the defect detection device 21.

A dancing roller 30, which is a tension control device, is provided at the downstream side of the defect detection device 21. This dancing roller 30 comprises fixed rollers 30A and 30B, and a moving roller 30C provided between the fixed rollers 30A, 30B. The tension of the sheet W is thus controlled by the up-down action of the moving roller 30C.

A second suction drum 26 is provided at the downstream side of the dancing roller 30. As described above, and as with the first suction drum 24, this second suction drum 26 is a device for supporting the sheet W by suction while also causing the sheet W to continuously run by being rotated at a fixed circumferential velocity.

An edge position control device (edge position controller) 32 is provided at the downstream side of the second suction drum 26. This edge position control device 32 is a device which detects the edge positions in the width direction of the continuously-running sheet W to control the width direction position of the sheet W.

The edge position control device 32 comprises fixed rollers 32A and 32B, and inclined rollers 32C and 32D provided between the fixed rollers 32A, 32B. The width direction of the sheet W is controlled by the inclined action of the inclined rollers 32C and 32D so that the width direction position of the sheet W is at a correct position as determined by the results detected from a (not-shown) edge position sensor (e.g. a laser system position sensor).

A sheet take-up device 18 stores the peeled sheet W, and is configured by a take-up roll or the like which takes-up the sheet W. At this sheet take-up device 18, a protective film H, which is supplied by the protective film supplying device 17 provided adjacently thereto, is supplied onto a surface of the sheet W. Both of these films are received together by the sheet take-up device 18 as a pair of sheets which are in close contact with each other.

Next, the respective materials used in the present invention will be explained. As the sheet W, resin film, paper (resin coated paper, synthetic paper and the like), metal foil (aluminum web and the like) can be used. Examples of materials which can be used as the resin film include various kinds of known plastics, for example, polyethylene, polypropylene, polyvinyl chloride, polyvinylidene chloride, polyvinyl acetate, polyester, polyolefin, acrylate, polystyrene, polycarbonate, polyamide, PET (polyethylene terephthalate), biaxially drawn polyethylene terephthalate, polyethylene naphthalate, polyamideimide, polyimide, aromatic polyamide, cellulose acylate, cellulose triacetate, cellulose acetate propionate, cellulose diacetate and the like. Among these examples, especially preferable are polyester, cellulose acylate, acrylate, polycarbonate and polyolefin.

The width of the sheet W is generally set at 0.1 to 3 m, the length of the sheet W is generally set at 1,000 to 100,000 m, and the thickness of the sheet W is generally set at 1 to 300 μm. However, this does not prevent other sizes from being adopted.

The sheet W may be subjected in advance to corona discharge, plasma treatment, adhesion facilitating treatment, heat treatment, dust removing treatment and the like. The surface roughness Ra of the sheet W is preferably 3 to 10 nm at the cut off value of 0.25 mm.

The sheet W may also be formed in advance with a base layer such as a bonding layer which has then been dried and hardened, or some other functional layer on a rear surface or the like. Similarly, the sheet W may be a single layer structure or a structure consisting of two layers or more. Further, the sheet W is preferably a transparent or semi-transparent object through which light can pass.

Resins which can be used in the present invention include resins which comprise a compound that generates a reactive species, such as a radical, a cation or the like, which can cause a compound containing a reactive group, such as a (meth)acryloyl group, a vinyl group, an epoxy group or the like, to react with said compound containing a reactive group by radiation irradiation such as UV-rays or the like.

In terms of curing speed, especially preferable is the combination of a reactive-group-containing compound (monomer) which contains an unsaturated group such as a (meth)acryloyl group, a vinyl group or the like, and a radical photoinitiator which generates a radical from light. Preferable among these are (meth)acryloyl-group-containing compounds such as (meth)acrylate, urethane (meth)acrylate, epoxy (meth)acrylate, polyester (meth)acrylate, and the like.

As this (meth)acryloyl-group-containing compound, compounds containing one (meth)acryloyl group or compounds containing two or more (meth)acryloyl groups can be used. In addition, the reactive-group-containing compound (monomer) which contains an unsaturated group such as the above-described acryloyl group or vinyl group can be used either individually or with several kinds mixed together as necessary.

Examples of such (meth)acryloyl-group-containing compounds include, as monofunctional monomers containing only one (meth)acryloyl-group-containing compound, isobornyl(meth)acrylate, bornyl(meth)acrylate, tricyclodecanyl(meth)acrylate, dicyclopentanyl(meth)acrylate, dicyclopentenyl(meth)acrylate, cyclohexyl(meth)acrylate, benzyl(meth)acrylate, 4-butylcyclohexyl(meth)acrylate, acryloylmorpholine, 2-hydroxyethyl(meth)acrylate, 2-hydroxypropyl(meth)acrylate, 2-hydroxybutyl(meth)acrylate, methyl(meth)acrylate, ethyl(meth)acrylate, propyl(meth)acrylate, isopropyl(meth)acrylate, butyl(meth)acrylate, amyl(meth)acrylate, isobutyl(meth)acrylate, t-butyl(meth)acrylate, pentyl(meth)acrylate, isoamyl(meth)acrylate, hexyl(meth)acrylate, heptyl(meth)acrylate, octyl(meth)acrylate, isooctyl(meth)acrylate, 2-ethylhexyl(meth)acrylate, nonyl(meth)acrylate, decyl(meth)acrylate, isodecyl(meth)acrylate, undecyl(meth)acrylate, dodecyl(meth)acrylate, lauryl(meth)acrylate, stearyl(meth)acrylate, isostearyl(meth)acrylate, tetrahydrofurfuryl(meth)acrylate, butoxyethyl(meth)acrylate, ethoxydiethylene glycol(meth)acrylate, polyethylene glycol mono(meth)acrylate, polypropylene glycol mono(meth)acrylate, methoxyethylene glycol(meth)acrylate, ethoxyethyl(meth)acrylate, methoxypolyethylene glycol(meth)acrylate, and methoxypolypropylene glycol(meth)acrylate.

Examples of monofunctional monomers further having an aromatic ring include phenoxyethyl(meth)acrylate, phenoxy-2-methylethyl(meth)acrylate, phenoxyethoxyethyl(meth)acrylate, 3-phenoxy-2-hydroxypropyl(meth)acrylate, 2-phenylphenoxyethyl(meth)acrylate, 4-phenylphenoxyethyl(meth)acrylate, 3-(2-phenylphenyl)-2-hydroxypropyl(meth)acrylate, (meth)acrylate of p-cumylphenol which is reacted with ethylene oxide, 2-bromophenoxyethyl(meth)acrylate, 4-bromophenoxyethyl(meth)acrylate, 2,4-dibromophenoxyethyl(meth)acrylate, 2,6-dibromophenoxyethyl(meth)acrylate, 2,4,6-tribromophenyl(meth)acrylate, and 2,4,6-tribromophenoxyethyl(meth)acrylate.

Examples of commercially available monofunctional monomers having an aromatic ring include Aronix M113, M110, M101, M102, M5700 and TO-1317 (manufactured by Toagosei Co., Ltd.), Viscoat #192, #193, #220 and 3BM (manufactured by Osaka Organic Chemical Industry Co., Ltd.), NK Ester AMP-10G and AMP-20G (manufactured by Shin-Nakamura Chemical Corporation), Light Acrylate PO-A, P-200A, Epoxy Ester M600A and Light Ester PO (manufactured by Kyoeisha Chemical Co., Ltd.), and New Frontier PHE, CEA, PHE-2, BR-30, BR-31, BR-31M and BR-32 (manufactured by Dai-ichi Sangyo Co., Ltd.).

Further, examples of unsaturated monomers having two (meth)acryloyl groups in the molecules include alkyldiol diacrylates such as 1,4-butanediol diacrylate, 1,6-hexanediol diacrylate, and 1,9-nonanediol diacrylate; polyalkylene glycol diacrylates such as ethylene glycol di(meth)acrylate, tetraethylene glycol diacrylate and tripropylene glycol diacrylate; neopentyl glycol di(meth)acrylate; and tricyclodecanemethanol diacrylate.

Examples of unsaturated monomers having a bisphenol skeleton include ethylene oxide-added bisphenol A(meth)acrylic ester, ethylene oxide-added tetrabromobisphenol A(meth)acrylic ester, propylene oxide-added bisphenol A(meth)acrylic ester, propylene oxide-added tetrabromobisphenol A(meth)acrylic ester, bisphenol A epoxy(meth)acrylate obtained by an epoxy ring-opening reaction of bisphenol A diglycidyl ether and (meth)acrylic acid, tetrabromobisphenol A epoxy(meth)acrylate obtained by an epoxy ring-opening reaction of tetrabromobisphenol A diglycidyl ether and (meth)acrylic acid, bisphenol F epoxy(meth)acrylate obtained by an epoxy ring-opening reaction of bisphenol F diglycidyl ether and (meth)acrylic acid and tetrabromobisphenol F epoxy(meth)acrylate obtained by an epoxy ring-opening reaction of tetrabromobisphenol F diglycidyl ether and (meth)acrylic acid.

Examples of commercially available unsaturated monomers having such a structure include Viscoat #700 and #540 (manufactured by Osaka Organic Chemical Industry Co., Ltd.), Aronix M-208 and M210 (manufactured by Toagosei Co., Ltd.), NK Ester BPE-100, BPE-200, BPE-500 and A-BPE-4 (manufactured by Shin-Nakamura Chemical Corporation), Light Ester BP4EA, BP4PA, Epoxy Ester 3002M, 3002A, 3000M, and 3000A (manufactured by Kyocisha Chemical Co., Ltd.), KAYARAD R-551 and R-712 (manufactured by Nippon Kayaku Co., Ltd.), BPE-4, BPE-10 and BR-42M (manufactured by Dai-ichi Sangyo Co., Ltd.), Lipoxi VR-77, VR-60, VR-90, SP-1506, SP-1507, SP-1509 and SP-1563 (manufactured by Showa Highpolymer Co., Ltd.), and Neopole V779 and Neopole V779MA (manufactured by Japan U-PiCA Co., Ltd.).

Examples of (meth)acrylate unsaturated monomers having three or more functional groups include (meth)acrylates of an alcohol having three or more hydroxyl groups such as trimethylolpropane tri(meth)acrylate, pentaerythritol tri(meth)acrylate, trimethylolpropane trioxyethyl(meth)acrylate, and tris(2-acryloyloxyethyl)isocyanurate. Commercially available examples include Aronix M305, M309, M310, M315, M320, M350, M360 and M408 (manufactured by Toagosei Co., Ltd.), Viscoat #295, #300, #360, GPT, 3PA and #400 (manufactured by Osaka Organic Chemical Industry Co., Ltd.), NK Ester TMPT, A-TMPT, A-TMM-3, A-TMM-3L and A-TMMT (manufactured by Shin-Nakamura Chemical Co., Ltd.), Light Acrylate TMP-A, TMP-6EO-3A, PE-3A, PE-4A and DPE-6A (manufactured by Kyoeisha Chemical Co., Ltd.), and KAYARAD PET-30, GPO-303, TMPTA, TPA-320, DPHA, D-310, DPCA-20 and DPCA-60 (manufactured by Nippon Kayaku Co., Ltd.).

The composition of the present invention may further include a urethane(meth)acrylate oligomer. Examples of the urethane(meth)acrylate include urethane(meth)acrylate oligomers prepared from a polyether polyol such as polyethylene glycol and polytetramethyl glycol, polyester polyol obtained by the reaction of a dibasic acid such as succinic acid, adipic acid, azelaic acid, sebacic acid, phthalic acid, tetrahydrophthalic acid (anhydride), hexahydrophthalic acid (anhydride) with a diol such as ethylene glycol, propylene glycol, diethylene glycol, triethylene glycol, tetraethylene glycol, dipropylene glycol, 1,4-butanediol, 1,6-hexanediol, and neopentyl glycol, polyecaprolactone-modified polyol, polymethylvalerolactone-modified polyol, alkyl polyol such as ethylene glycol, propylene glycol, 1,4-butanediol, 1,6-hexanediol and neopentyl glycol, bisphenol A skeleton alkylene oxide modified polyol such as ethylene oxide-added bisphenol A and propylene oxide-added bisphenol A, bisphenol F skeleton alkylene oxide modified polyol such as ethylene oxide-added bisphenol F and propylene oxide-added bisphenol F, or a mixture of these and an organic polyisocyanate such as tolylene diisocyanate, isophorone diisocyanate, hexamethylene diisocyanate, diphenylmethane diisocyanate, and xylylene diisocyanate, and a hydroxyl group-containing (meth)acrylate such as 2-hydroxyethyl(meth)acrylate and 2-hydroxypropyl(meth)acrylate. Use of the urethane(meth)acrylate oligomer is preferable in order to maintain the viscosity of the curable composition of the present invention at a moderate level.

Examples of commercially available monomers of urethane (meth)acrylate include Aronix M-120, M-150, M-156, M-215, M-220, M-225, M-240, M-245 and M-270 (manufactured by Toagosei Co., Ltd.), AIB, TBA, LA, LTA, STA, Viscoat #155, IBXA, Viscoat #158, #190, #150, #320, HEA, HPA, Viscoat#2000, #2100, DMA, Viscoat #195, #230, #260, #215, #335HP, #310HP, #310HG and #312 (manufactured by Osaka Organic Chemical Industry Co., Ltd.), Light Acrylate IAA, L-A, S-A, BO-A, EC-A, MTG-A, DMP-A, THF-A, IB-XA, HOA, HOP-A, HOA-MPL, HOA-MPE, Light Acrylate 3EG-A, 4EG-A, 9EG-A, NP-A, 1,6HX-A and DCP-A (manufactured by Kyoeisha Chemical Co., Ltd.), KAYARAD TC-110S, HDDA, NPGDA, TPGDA, PEG400DA, MANDA, HX-220 and HX-620 (manufactured by Nippon Kayaku Co., Ltd.), FA-511A, 512A and 513A (manufactured by Hitachi Chemical Co., Ltd.), VP (manufactured by BASF), and ACMO, DMAA and DMAPAA (manufactured by Kohjin Co., Ltd.).

The urethane (meth)acrylate oligomer is obtained as the reaction product of (a) a hydroxy-group-containing (meth)acrylate, (b) an organic polyisocyanate and (c) a polyol. Preferably, the urethane (meth)acrylate oligomer is a reaction product obtained by reacting (a) a hydroxy-group-containing (meth)acrylate and (b) an organic polyisocyanate, and then reacting the resulting product with (c) a polyol.

These unsaturated monomers may be used either individually or with several kinds mixed together as necessary.

Examples of the radical photoinitiator include acetophenone, acetophenonebenzylketal, 1-hydroxycyclohexylphenylketone, 2-2-dimethoxy-2-phenylacetophenone, xanthone, fluorenone, benzaldehyde, fluorene, anthraquinone, triphenylamine, carbazol, 3-methyl-acetophenone, 4-chlorobenzophenone, 4,4′-dimethoxybenzophenone, 4,4′-diaminobenzophenone, Michler's ketone, benzoinpropyl ether, benzomethyl ether, benzyldimethyl-ketal, 1-(4-isopropylphenyl)-2-hydroxy-2-methyl-propane-1-one, 2-hydroxy-2-methyl-1-phenylpropane-1-one, thioxanthone, diethylthioxanthone, 2-isopropylthioxanthone, 2-chlorothioxanthione, 2-methyl-1-[4-(methyl-thio)phenyl]-2-morpholino-propane-1-one, 2,4,6-trimethylbenzoyldiphenylphosphine oxide, bis-(2,6-dimethoxybenzoyl)-2,4,4-trimethylpentylphosphine oxide, ethyl-2,4,6-trimethyl-benzoylethoxyphenylphosphine oxide.

Examples of commercially available radical photoinitiators include Irgacure 184, 369, 651, 500, 819, 907, 784, 2959, CGI1700, CGI1750, CGI11850, CG24-61, Darocur 116 and 1173 (manufactured by Ciba Specialty Chemicals Co., Ltd.), Lucirin LR8728 and 8893X (manufactured by BASF), Ubecryl P36 (manufactured by UCB) and KIP150 (manufactured by Lamberti Spa). Among these examples, Lucirin LR8893X is preferable, since it is easily dissolved in liquid state and has a high sensitivity.

The content of the radical photoinitiator in the total composition is preferably 0.01 to 10% by weight, and particularly preferably 0.5 to 7% by weight. The upper limit is preferably set in view of ensuring the curing properties of the composition, mechanical characteristics and optical characteristics of the cured product, handling capability, and the like. The lower limit is preferably set for preventing a decrease in the curing speed.

The composition of the present invention may further comprise a photosensitizer. Examples of the photosensitizer include triethylamine, diethylamine, N-methyldiethanoleamine, ethanolamine, 4-dimethylaminobenzoic acid, methyl 4-dimethylaminobenzoate, ethyl 4-dimethylaminobenzoate and isoamyl 4-dimethylaminobenzoate. Commercially available examples include Ubecryl P102, 103, 104, and 105 (manufactured by UCB).

In addition to the above components, additives such as antioxidants, UV absorbers, light stabilizers, silane coupling agents, coating surface improvers, heat-polymerization inhibitors, leveling agents, surfactants, coloring agents, preservatives, plasticizers, lubricants, solvents, fillers, aging preventives, wettability improvers and mold release agents may optionally be added.

Examples of antioxidants include Irganox 1010, 1035, 1076 and 1222 (manufactured by Ciba Specialty Chemicals Co., Ltd.), and Antigen P, 3C, FR and GA-80 (manufactured by Sumitomo Chemical Industries Co., Ltd.). Examples of UV absorbers include Tinuvin P, 234, 320, 326, 327, 328, 329 and 213 (manufactured by Ciba Specialty Chemicals Co., Ltd.), and Seesorb 102, 103, 110, 501, 202, 712 and 704 (manufactured by Sypro Chemical Co., Ltd.). Examples of light stabilizers include Tinuvin 292, 144 and 622LD (manufactured by Ciba Specialty Chemicals Co., Ltd.), Sanol LS770 (manufactured by Sankyo Co., Ltd.) and Sumisorb TM-061 (manufactured by Sumitomo Chemical Industries Co., Ltd.). Examples of silane coupling agents include γ-aminopropyltriethoxysilane, γ-mercaptopropyltrimethoxysilane, and γ-methaeryloxypropyltrimethoxysilane, and commercially available products such as SH6062 and SH6030 (manufactured by Toray-Dow Corning Silicone Co., Ltd.), and KBE903, KBE603 and KBE403 (manufactured by Shin-Etsu Chemical Co., Ltd.). Examples of coating surface improvers include silicone additives such as dimethylsiloxane polyether and commercially available products such as DC-57 and DC-190 (manufactured by Dow-Corning), SH-28PA, SH-29PA, SH-30PA and SH-190 (manufactured by Toray-Dow Corning Silicone Co., Ltd.), KF351, KF352, KF353 and KF354 (manufactured by Shin-Etsu Chemical Co., Ltd.), and L-700, L-7002, L-7500 and FK-024-90 (manufactured by Nippon Unicar Co., Ltd.). Commercially available examples of nonionic fluorosurfactants include FC-430 and FC-171 (manufactured by 3M Corporation), and Megafac F-176, F-177, R-08 and F780 (manufactured by Dai Nippon Printing Co., Ltd.). Examples of mold release agents include Plysurf A208F (manufactured by Dai-ichi Sangyo Co., Ltd.).

The organic solvent for viscosity control of the resin solution according to the present invention may be any solvent which can be mixed with the resin solution without any non-uniformity such as precipitation, phase separation, milkiness or the like. Examples which can be used include acetone, methyl ethyl ketone, methyl isobutyl ketone, ethanol, propanol, butanol, 2-methoxyethanol, cyclohexanol, cyclohexane, cyclohexanone, toluene and the like. These may also be used by mixing a plurality together as necessary.

In the case of adding an organic solvent, a step of drying and evaporating the organic solvent becomes necessary during the production steps of the product. However, if a large amount of unevaporated solvent remains in the product, the mechanical strength of the product deteriorates, which can cause offensive odors or adverse effects on health from evaporation and dispersal of the organic solvent when being used as a product. Thus, it is not preferable to use a large amount of an organic solvent having a high boiling point, as the residual solvent amount will increase.

However, if the boiling point is too low, evaporation is very vigorous, which makes the surface shape rough. This can cause dew condensation water to adhere to the composition surface from the heat of vaporization during drying, whereby the resulting marks become surface defects. This causes the vapor concentration to increase, thereby increasing the risks of ignition or the like.

Accordingly, the boiling point of the organic solvent is preferably from 50° C. or more to 150° C. or less, and more preferably, 70° C. or more to 120° C. or less. From the perspective of the material solubility and boiling point, the organic solvent is preferably methyl ethyl ketone (bp of 79.6° C.), 1-propanol (bp of 97.2° C.) or the like.

The added amount of organic solvent added into the resin solution according to the present invention varies depending on the type of solvent and the viscosity of the resin solution prior to the solvent being added. To sufficiently improve coatability, the added amount is in a range of 10% by weight or more to 40% by weight or less, and is preferably in a range of 15% by weight or more to 30% by weight or less. If the added amount of organic solvent is too small, the effects of lowering viscosity and the effects of increasing the coating amount are small, so that coatability does not sufficiently improve.

However, if the resin solution is overly diluted, the viscosity is too low, which causes problems such as streaks to form from the liquid running on the sheet-shaped object, or liquid to flow over to the back face of the sheet-shaped object. Further, drying may be insufficient during the drying step, which can cause a large amount of organic solvent to remain in the product. This can cause product function to deteriorate, or give rise to offensive odors or adverse effects on health from vaporization when being used as a product.

The resin solution according to the present invention can be produced by mixing the above-described respective components by a well-known method, and if necessary, it can be produced by thermal dissolution. The viscosity of a resin solution prepared in such a manner is usually 10 to 50,000 mPa·s/25° C.

When supplying the resin solution to the sheet W or the embossing roller 13, if the viscosity is too high, it becomes difficult to supply the composition uniformly. In the case of producing a lens, this can cause coating streaks or swells, whereby air bubbles may form therein. It thus becomes more difficult to obtain the desired lens thickness, so that function as a lens cannot be sufficiently expressed.

This trend is especially noticeable when the line speed is increased. Therefore, in such case a lower viscosity is preferable. A viscosity of 10 to 100 mPa·s is preferable, and more preferable is 10 to 50 mPa·s. Such a low viscosity enables control by adding a suitable amount of the organic solvent. It is also possible to control the viscosity by setting of the coating solution at a narrow temperature range.

On the other hand, if the viscosity is too low after the solvent has evaporated off, the lens thickness is difficult to control when it is embossed with the embossing roller 13, whereby a uniform lens having a fixed thickness cannot always be formed. A preferable viscosity is 10 to 3,000 mPa·s. When mixing the organic solvent, providing a step of evaporating the organic solvent by drying with heat or the like between the step of supplying the resin solution and the step of embossing with the embossing roller 13 allows the liquid to be supplied uniformly at a low viscosity when the resin solution is being supplied. This enables the organic solvent to be dried when embossing with the embossing roller 13, whereby the embossing can be carried out uniformly with a resin solution having a higher viscosity.

If the cured product obtained by curing the resin solution according to the present invention with radiation is a prism lens sheet, it is especially preferable for the cured product to have the following physical properties (refractive index, softening point).

The refractive index of the cured product at 25° C. is preferably 1.55 or higher, and more preferably, 1.56 or higher. This is because if the refractive index of the cured product at 25° C. is less than 1.55, when a prism lens sheet is formed using the present composition, it may not be possible to attain sufficient surface brightness.

The softening point is preferably 40° C. or higher, and is more preferably 50° C. or higher. This is because if the softening point is less than 40° C., heat resistance may not be sufficient.

Returning to FIG. 1, the action of the production apparatus 10 for an embossed sheet will now be explained. The sheet W is fed at a fixed rate by the sheet-shaped object supplying device 11. The sheet W is wound onto the first suction drum 24, and continuously runs while being supported by suction. The sheet W is then fed through a dust remover 28, whereby dust adhered to the surface of the sheet W is removed.

Next, the sheet W is fed through a coating device 12, and a resin solution is coated onto the surface of the sheet W. After coating, the resin solution coated on the sheet W is dried by a drying device, whereby the solvent component evaporates. Thus, since a step of drying the solvent contained in the coated layer is provided before winding the sheet W onto the embossing roller 13 and curing, there is no fear of the product function deteriorating or the strength of the cured film deteriorating as a result of added solvent remaining even after curing. Similarly, there is also no fear of offensive odors or adverse effects on health arising from solvent being released during use of the product.

Next, the sheet W is fed to a molding device consisting of the embossing roller 13 and the nip roller 14. As a result, the continuously running sheet W is subjected to roller molding while being pressed by the rotating embossing roller 13 and nip roller 14 at a three o'clock position of the embossing roller 13. Specifically, the sheet W is wound onto the rotating embossing roller 13, and indents on the embossing roller 13 surface are transferred to the resin layer.

Next, with the sheet W wound onto the embossing roller 13, resin curing device 15 irradiates radiation through the sheet W onto the resin solution layer, whereby the resin solution layer is cured. The sheet W is then peeled from the embossing roller 13 by winding onto the peeling roller 16 at a nine o'clock position of the embossing roller 13.

While not shown in FIG. 1, after the sheet W has been peeled off, radiation irradiation can again be carried out to further promote curing.

As described above, the series of processes of winding the sheet W having a resin layer formed on its surface onto the rotating embossing roller 13 to transfer indents on the embossing roller 13 surface to the resin layer, and with the sheet W wound onto the embossing roller 13, irradiating radiation from the resin curing device 15 onto the resin layer to cure the resin layer, and then peeling the sheet W from the embossing roller 13, are carried out inside the casing 40. At this stage, since the temperature and humidity in the casing 40 are each controlled to be within a certain variation range with respect to a target value, a product having good quality can be produced without having defects such as structural change in the formed pattern or peeling faults.

The peeled sheet W is conveyed to a defect detection device 21, and defects in the indented pattern which has been transferred onto the sheet W are detected. With such a defect detection device 21, defects in the indented pattern transferred onto the sheet W can be detected, thus making removal of the defective portions easy.

Next, the sheet W is conveyed to a dancing roller 30, where the tension of the sheet W is controlled by the up-down action of a moving roller 30C provided between fixed rollers 30A, 30B. The tension of the sheet W is controlled by such a dancing roller 30 (tension control device), which stabilizes the running velocity of the sheet W, thus making the transferred shape good.

Next, the sheet W is wound onto a second suction drum 26, and continuously run while being supported by suction.

Next, the sheet W is conveyed to an edge position control device 32, where the width direction position of the sheet W is controlled. The indented sheet according to the present invention forms a fine pattern on the sheet surface. Thus, if there is any bias or fluctuation of the sheet during its conveyance, the sheet is very liable to become defective. Accordingly, if the width direction position of the sheet-shaped object can be controlled, occurrence of such defects can be effectively prevented.

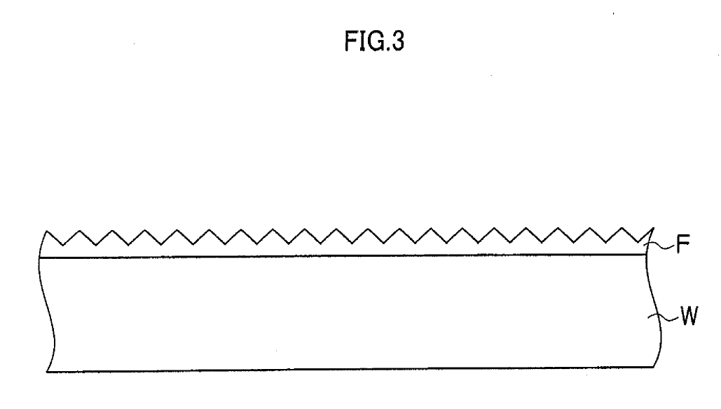

Next, the sheet W is conveyed to a sheet take-up device 18, where a protective film H, which is supplied by the protective film supplying device 17, is supplied onto the surface of the sheet W. Both of these films are taken up by the take-up roll of the sheet take-up device 18 overlapping each other, and stored. FIG. 3 illustrates a schematic cross-sectional shape of such a sheet W after completion. A resin layer F with the indents of the embossing roller 13 surface transferred thereon is formed on the surface of the sheet W.

The completed sheet W which has been taken-up and stored by the take-up roll can also be cut to product size offline once the series of steps has been carried out. Such a completed sheet W can be preferably used as an optical film.

In the above-described present embodiment, according to a series of steps carried out from the upstream side, a radiation curable resin is coated onto the surface of a sheet W, and this sheet W is wound onto an embossing roller 13 to transfer indents on its surface. In this state, radiation is irradiated to cure the coated layer, and the sheet W is peeled from the embossing roller 13. Either one or both surfaces are laminated with a protective film H, and the resultant product is taken-up in a roll shape. Therefore, the processes as far as take-up are carried out in one series of steps, thereby allowing a product to be efficiently produced at a high line speed and which has good quality without defects.

Especially, a high quality product can be produced without a decrease in accuracy of the formed pattern structure or defects caused by peeling faults, since the processes from transfer to curing and peeling are carried out inside a casing 40 in which the temperature and humidity are each controlled to be within a certain variation range with respect to a target value.

While an example of an embodiment of a method for producing the indented sheet according to the present invention was explained above, this example embodiment does not limit the present invention. Various other modes may also be embodied.

For example, while in the present example embodiment, a roller-shaped embossing roller 13 was employed, a mode using a structure having an indented pattern (embossed shape) on the surface of an endless belt or other such belt-shaped object may also be employed. Such a belt-shaped object acts in the same manner as a cylindrical roller, and the same effects can be obtained.

Specific examples of the present invention will now be explained. However, the present invention is not restricted to these examples.

### [Adjustment of the Resin Solution]

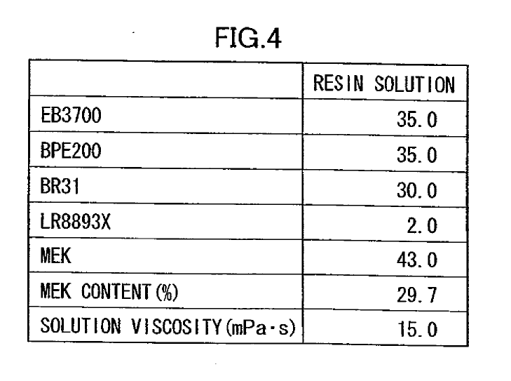

The compounds shown in the table of FIG. 4 were mixed in their described weight ratio, and the resultant mixture was heated to 50° C. and dissolved under stirring to yield resin solutions (coating solutions). The respective compound names and details are as follows.

EB3700: Ebecryl 3700, manufactured by Daicel UC Co., Ltd.

Bisphenol A type epoxy acrylate

(viscosity of 2,200 mPa·s/65° C.)

BPE200: NK ester BPE-200, manufactured by Shin-Nakamura Chemical Corporation

Ethylene oxide-added bisphenol A methacrylate

(viscosity of 590 mPa·s/25° C.)

BR-31: New Frontier BR-31, manufactured by Dai-ichi Sangyo Co., Ltd.

Tribromophenoxyethyl acrylate

(solid at room temperature; melting point of 50° C. or higher)

LR8893X: Lucirin LR8893X, manufactured by BASE, radical generator

Ethyl-2,4,6-trimethylbenzoyl ethoxyphenylphosphine oxide

MEK: Methyl ethyl ketone

### [Production of the Embossed Sheet]

An embossed sheet was produced using the production apparatus 10 for an embossed sheet configured as illustrated in FIG. 1.

As the sheet W, a film consisting of transparent PET (polyethylene terephthalate) and having a width of 500 mm and a thickness of 100 μm was used.

Used for the embossing roller 13 was a roller consisting of S45C having a length (sheet W width direction) of 700 mm and a diameter of 300 mm, and having a surface material of nickel. The entire circumference of the roller surface at an approximately 500 mm width was cut with a diamond cutting tool (single point) to form a groove having a roller shaft direction pitch of 50 μm. The cross-sectional shape of the groove was a triangle shape having a 90° apex angle. The bottom of the groove was also a 90° triangle shape having no flat section. Specifically, the groove width was 50 μm, and the groove depth was about 25 μm. Since this groove was endless with no seams in the circumference direction, a lenticular lens (prism sheet) having a triangular cross section could be formed on the sheet W by the embossing roller 13. The surface of the roller was coated with nickel after the grove had been formed.

A die coater was used as the coating device 12. As the coating head 12C, an extrusion type was used.

The coating solutions F (resin solutions) described in the table of the above-described FIG. 4 were used.

The damp state thickness of the coating solutions F (resin solutions) was controlled by a liquid supplying apparatus (feeding pump) 12B wherein the supplied amount of the coating solutions F to the coating head 12C was such that the film thickness once the organic solvent had been dried was 20 μm.

A hot-air circulation system apparatus was used as the drying device 19. The solvent concentration in the coating solutions F was regulated according to the coating conditions (temperature of the hot air etc.) after coating.

Used as the nip roller 14 was a roller having a diameter of 200 mm and which had on its surface a silicone rubber layer with a rubber hardness degree of 90. The nip pressure (effective nip pressure) pressing the sheet W by the embossing roller 13 and the nip roller 14 was 0.5 Pa.

A metal halide lamp was used for the resin curing device 15, and irradiation was carried out at an energy of 1,000 mJ/cm².

The slit-shaped aperture (for sheet passage) formed in the casing 40 had a long side which was 5 mm longer than the sheet width to both the left and the right (i.e. sheet width +10 mm), and a short side which was 5 mm longer than the sheet thickness both above and below (i.e. sheet thickness +10 mm). Obviously, the structure of the slit-shaped aperture was such that the aperture size could be adjusted.

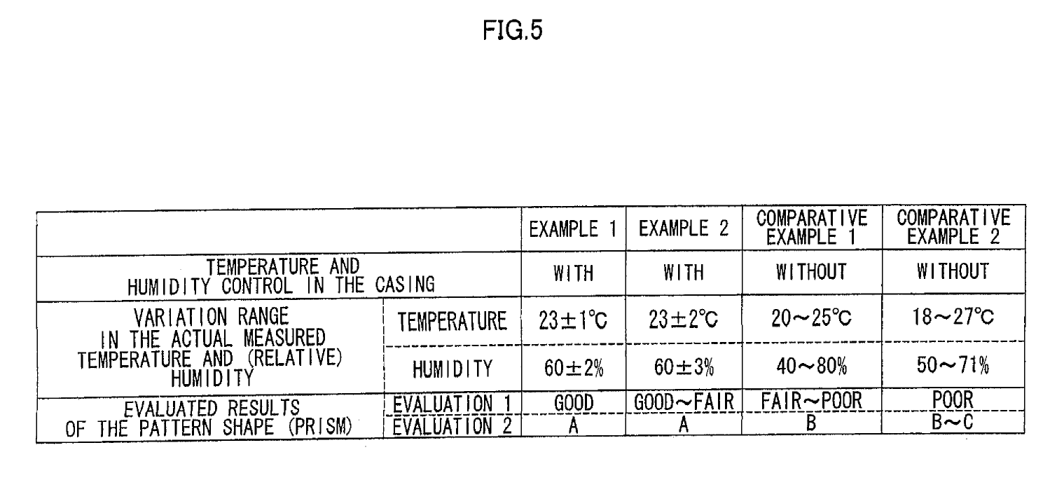

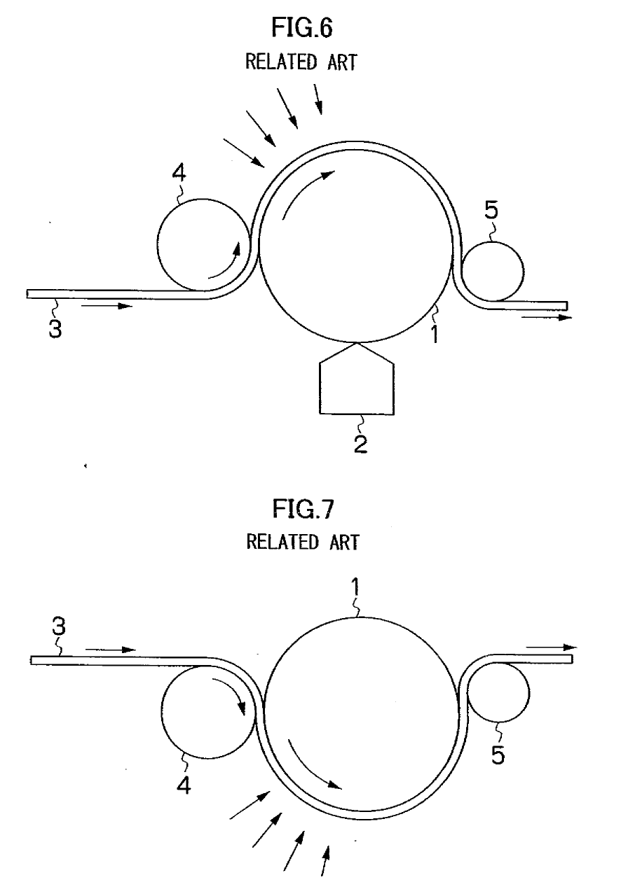

The respective Example and Comparative example samples (sheet W formed with an indented pattern) were then produced in accordance with the temperature and humidity control conditions in the casing 40 as shown in the table of FIG. 5.

### [Evaluation of Pattern Shape]

First, as evaluation 1, the obtained sheets W were cut and evaluated for their pattern shape (prism shape) by measuring the cross-sectional shape of the indented pattern at a plurality of locations using an SEM (scanning electron microscope). Determination was made using the following three grades: sheet Ws wherein the embossing roller 13 surface shape was reproduced were evaluated as “Good”; sheet Ws wherein there was slight deformation (less than 1 μm) were evaluated as “Fair”; and sheet Ws wherein was significant deformation (1 μm or more) were evaluated as “Poor”.

Second, as evaluation 2, the surface of the indented pattern at a plurality of locations was visually observed, and a determination was made using the following three grades: objects having no more than 5 defects per m² were evaluated as “A”, those having 6 to 19 defects per m² were evaluated as “B”, and those having 20 defects per m² or more were evaluated as “C”.

The evaluated results of embossed sheets produced by the above-described production method but while varying the presence of temperature and humidity control in the casing 40 are given in the table of FIG. 5.

According to the table of FIG. 5, Example 1, wherein the control of temperature and humidity in the casing 40 was carried out at ±1° C. of the target temperature (23° C.) and ±2% of the target humidity (60%), had a pattern shape evaluation as Good and A, thus attaining very commendable results. Further, with the same control as in Example 1, Example 2, which was carried out at ±2° C. of the target temperature (23° C.) and ±4% of the target humidity (60%), had a pattern shape evaluation as Good to Fair and A, thus also attaining commendable results.

In contrast, Comparative example 1, wherein the control of temperature and humidity in the casing 40 was not carried out, and the temperature varied in the range of 20 to 25° C. and humidity in the range of 50 to 70%, had a pattern shape evaluation as Fair to Poor and B, and thus had an overall evaluation of “no good” (NG). Similar to Comparative example 1, Comparative example 2, wherein the control of temperature and humidity in the casing 40 was not carried out, and the temperature varied in the range of 18 to 27° C. and humidity in the range of 40 to 80%, had a pattern shape evaluation as Poor and B to C, and thus had an overall evaluation of “no good” (NG).

The above results confirmed the advantageous effects of the present invention; i.e. that a high quality indented sheet can be produced using the method according to the present invention without a decrease in accuracy of the formed pattern structure or defects caused by peeling faults.

1. A method of producing an indented sheet, an indent on a surface of an indented roller are transferred onto a surface of a sheet-shaped object, comprising the steps of:
continuously running a band-shaped flexible sheet-shaped object;
coating a radiation curable resin solution on a surface of the continuously running sheet-shaped object to form a coated layer;
transferring the indent on the surface of the indented roller onto the coated layer with the continuously running sheet-shaped object being wound onto the rotating indented roller;
a curing step of curing the coated layer by irradiating radiation with the continuously running sheet-shaped object being wound onto the indented roller; and
a peeling step of peeling the continuously running sheet-shaped object from the indented roller, wherein
the transferring step, curing step, and peeling step are carried out inside a casing, and
temperature and humidity in the casing are each controlled to be within a certain variation range with respect to a target value.

2. The method of producing the indented sheet according to claim 1, wherein
an air is supplied to and discharged from the casing interior, and the air supplied into the casing is air from which dust has been removed by a filter.

3. The method of producing the indented sheet according to claim 1, wherein
the air in the casing has a higher pressure than external air.

4. The method of producing the indented sheet according to claim 1, wherein
a cooling water is supplied into the roller.

5. The method of producing the indented sheet according to claim 1, wherein
the radiation curable resin is a UV-ray curable resin and the radiation is UV rays.

6. The method of producing the indented sheet according to claim 1, wherein
a pitch of the indented pattern transferred onto the sheet-shaped object is no more than 100 μm.

7. The method of producing the indented sheet according to claim 1, wherein
the indented sheet is intended to be used as an optical film.

8. The method of producing the indented sheet according to claim 2, wherein
the air in the casing has a higher pressure than external air.

9. The method of producing the indented sheet according to claim 8, wherein
a cooling water is supplied into the roller.

10. The method of producing the indented sheet according to claim 9, wherein
the radiation curable resin is a UV-ray curable resin and the radiation is UV rays.

11. The method of producing the indented sheet according to claim 10, wherein
a pitch of the indented pattern transferred onto the sheet-shaped object is no more than 100 μm.

12. The method of producing the indented sheet according to claim 11, wherein
the indented sheet is intended to be used as an optical film.
